(19) United States
(12) Patent Application Publication
(10) Pub. No.: US 2019/0374068 A1
(43) Pub. Date: Dec. 12, 2019

(54) KITCHEN UTENSIL HOLDER

(71) Applicant: Syvaina Orie Jones, Ardmore, OK (US)

(72) Inventor: Syvaina Orie Jones, Ardmore, OK (US)

(21) Appl. No.: 16/411,027

(22) Filed: May 13, 2019

Related U.S. Application Data
(60) Provisional application No. 62/641,845, filed on Mar. 12, 2018.

(51) Int. Cl. A47J 47/16; A47B 81/00

(52) U.S. Cl. CPC A47J 47/16; A47B 81/00

(57) ABSTRACT

A device including a tray and at least one utensil-holding member. The device is useful for holding multiple kitchen utensils and create a central location to rest the multiple kitchen utensils while cooking. The at least one utensil-holding member includes a serpentine configuration defining sections for receiving the kitchen utensils. The tray has a capacity to catch food and liquid drippings from the kitchen utensils.

### CROSS REFERENCE TO RELATED APPLICATION

The present application is related to and claims priority to U.S. Provisional Patent Application No. 62/641,845 filed Mar. 12, 2018, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. FIELD OF THE INVENTION

The present invention relates generally to the field of kitchen accessories and more specifically relates to a holder for kitchen utensils.

### 2. DESCRIPTION OF RELATED ART

When cooking, it often necessary to use multiple utensils, such as ladles, spatulas, spoons, and more. Existing devices are designed to allow users to lay a utensil down without creating a mess on a countertop. These devices do not accommodate more than one utensil. The other utensils tend to create countertop clutter and messes. A suitable solution is desired.

U.S. Pub. No. 2003/0205645 to Sascha Kaposi relates to a spoon and lid rest. The described spoon & lid rest includes a first bowl and a second bowl, either of which is capable of serving as a rest for a spoon or other utensil. An upright member such as an open wire rectangle holds lids in a substantially vertical position, with an edge of the lid retained within either the first or second bowl and a portion of the lid resting against the upright member.

### BRIEF SUMMARY OF THE INVENTION

In view of the foregoing disadvantages inherent in the known kitchen accessories art, the present disclosure provides a novel kitchen utensil holder. The general purpose of the present disclosure, which will be described subsequently in greater detail, is to provide a device designed to create a central location to rest multiple kitchen utensils while cooking; the utensils located above a planar of the counter or the like when engaged with the device. It may offer a convenient place to store more than one utensil on a counter when preparing food in a kitchen. The device may eliminate counter clutter by providing a storage place for multiple utensils and allows users to cook more efficiently.

A device is disclosed herein. The device includes a tray which may include a base and a raised lip around a periphery of the base; the base and the raised lip may define a tray-capacity that also functions as a drip tray. At least one utensil-holding member may be attached about a first end of the tray. The at least one utensil-holding member may include a length of a tubing (preferably cylindrical tubing so as not to have edges that catch on the utensil when removed or inserted) formed into a substantially serpentine configuration. The serpentine configuration may have a horizontal-length relative to the substantially horizontal surface and may define at least two utensil-holding sections. The at least two utensil-holding sections may each be configured to receive and hold the at least one kitchen utensil without contacting the planar surface of the counter.

A method of using device is also disclosed herein. The method of using device may comprise the steps of: providing the device as above; placing the device on the kitchen counter; using the at least one kitchen utensil for food preparation; placing the at least one kitchen utensil within one of the at least two utensil-holding sections whilst not needed; and removing the at least one kitchen utensil from the one of the at least two utensil-holding sections when needed for food preparation.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a kitchen utensil holder, constructed and operative according to the teachings of the present disclosure.

FIG. 1 is a front-side perspective view of the device during an ‘in-use’ condition, according to an embodiment of the disclosure.

FIG. 2 is a front-side perspective view of the device of FIG. 1, according to an embodiment of the present disclosure.

FIG. 3 is a front perspective view of the device of FIG. 1, according to an embodiment of the present disclosure.

FIG. 4 is a front-side perspective view of the device of FIG. 1, according to an embodiment of the present disclosure.

FIG. 5 is a flow diagram illustrating a method of use for device, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to kitchen accessories and more particularly to a kitchen utensil holder as used to improve holders for kitchen utensils.

Generally, disclosed is a kitchen accessory designed to hold multiple utensils when cooking. The accessory may be comprised of a ceramic, metal, or plastic dish approximately 6″ in length, and 4″ wide with approximately a ¼″ lip around the entire dish. Attached approximately 2″ in from a top edge of the dish in an upright horizontal position, may be an approximately 3″ tall and approximately 3″ wide large rounded wire in a serpentine or zigzag pattern. The utensils may be placed in areas within the serpentine or zigzag design. The dish may be designed to catch any drippings from utensils. The accessory may be available in various colors. The accessory may be dishwasher safe.

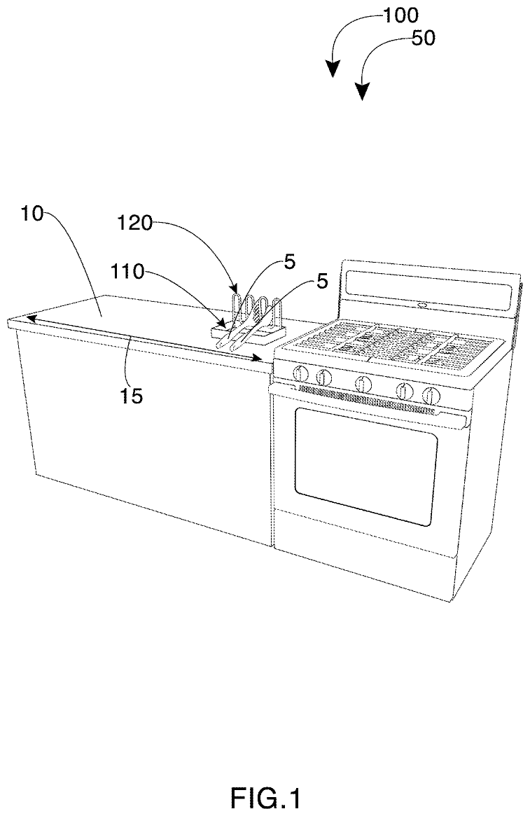

Referring now more specifically to the drawings by numerals of reference, there is shown in FIGS. 1-4, various views of a device 100.

FIG. 1 shows a device 100 during an ‘in-use’ condition 150, according to an embodiment of the present disclosure. As illustrated, the device 100 may include a tray and at least one utensil-holding member. As shown, the device 100 may be used for receiving and holding at least one kitchen utensil 5. The device 100 may be configured for storage on a kitchen counter 10, the kitchen counter 10 having a substantially horizontal surface 15.

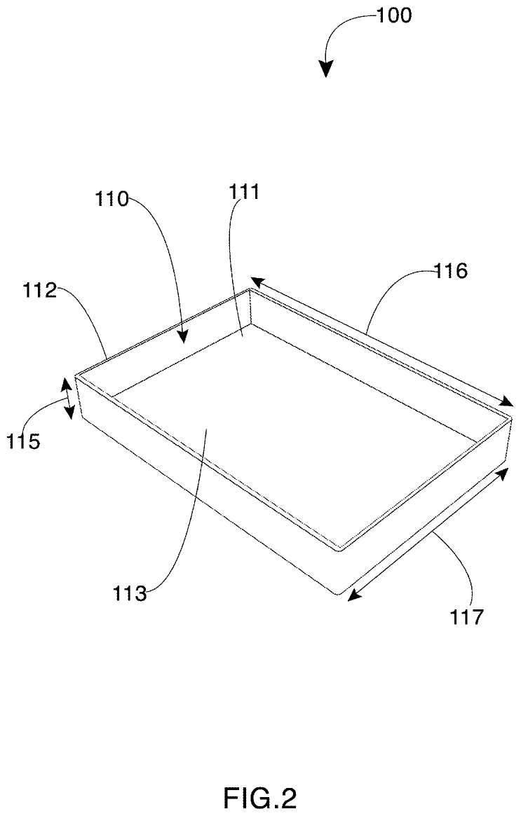

FIG. 2 shows a front-side perspective view of the device 100 of FIG. 1, according to an embodiment of the present disclosure. The tray may include a base 111 and a raised lip 112 around a periphery of the base 111. The tray may comprise a ceramic material, a metal material, a plastic material, or the like. Preferably, the material may be dishwasher safe so that a user is able to easily wash the device 100 when needed.

The base 111 and the raised lip 112 may define a tray-capacity 113. Further, the raised lip 112 may define a tray-depth 115 of between ¼-1 inch. Preferably, the tray-depth 115 may be ¼ inch. The tray may include a tray-width 116 of between 5-7 inches, or in some embodiments, the tray-width 116 may be 6 inches. In addition, the tray may include a tray-length 117 of between 3-5, or in some embodiments, the tray-length 117 may be 4 inches. One exemplary embodiment of the tray may include dimensions of 6 inches (width)×4 inches (length)×¼ inch (depth), However, it should be appreciated that the tray is not limited to dimensions listed here.

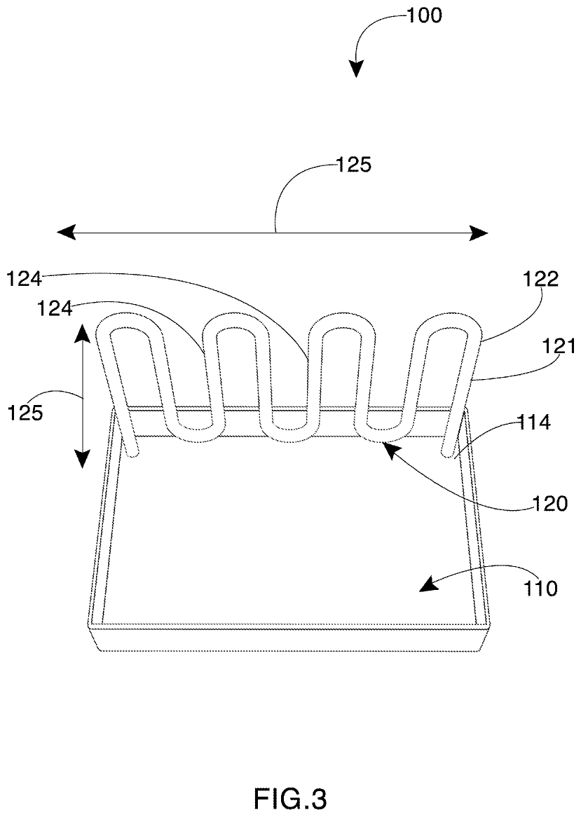

FIG. 3 shows a front perspective view of the device 100 of FIG. 1, according to an embodiment of the present disclosure. As shown, the at least one utensil-holding member 120 may be attached about a first end 114 of the tray. Shown in the figures is one utensil-holding member. However, in some embodiments, the device 100 may include more than utensil-holding member 120. The at least one utensil-holding member 120 may include a length of a tubing 121 formed into a substantially serpentine configuration 122. The serpentine configuration 122 may comprise smooth arcuate bends (preferred) or different angles and it should be noted that different distances can be used between the bends/curves/angled edges as are suitable for the utensils being stored. Preferably, the at least one utensil-holding member 120 may comprise a metal material. However, other materials such as plastic, silicone, ceramic, and the like, are also contemplated.

As shown here, the serpentine configuration 122 may have a horizontal-length 123 relative to the substantially horizontal surface 15 (FIG. 1) and may define at least two utensil-holding sections 124. As shown, the serpentine configuration 122 may include a plurality of curved edges, with an apex of each of the curved edges alternating between a top of the device 100 and a bottom of the device 100 (relative to the horizontal surface 15 (FIG. 1)). The utensil-holding sections 124 may be located in between two curved edges having their apex at the top of the device 100.

The at least one utensil-holding member 120 may have a member-height 125 of between 2-4 inches. In one embodiment, at least one utensil-holding member 120 may have a member-height 125 of 3 inches. Further, the at least one utensil-holding member 120 may include the horizontal-length 123 of between 2-4 inches. In one embodiment, the at least one utensil-holding member 120 may include a horizontal-length 123 of 3 inches. One exemplary embodiment of the at least one utensil-holding member 120 may include dimensions of 3 inches (length)×3 inches (height). However, it should be appreciated that the at least one utensil-holding member 120 is not limited to dimensions listed here.

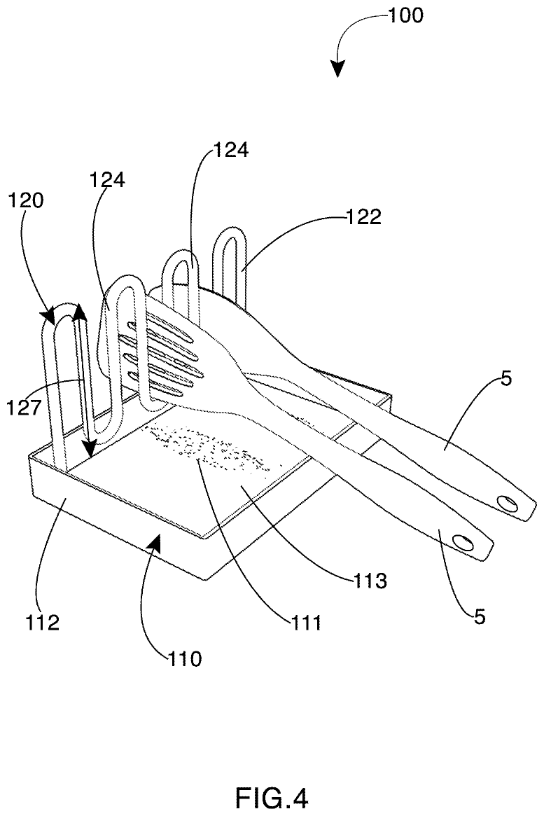

FIG. 4 shows a front-side perspective view of the device 100 of FIG. 1, according to an embodiment of the present disclosure. The at least two utensil-holding sections 124 may each be configured to receive and hold the at least one kitchen utensil 5. As above, the utensil-holding sections 124 may be located in between two curved edges having their apex at the top of the device 100. As such, the at least one kitchen utensil 5 may be removably placed in between the two curved edges having their apex at the top of the device 100. Preferably, the at least one utensil-holding member 120 may include more than two utensil-holding sections 124. It should be appreciated that the serpentine configuration 122 may be a continuous shape, and as such, the horizontal-length 123 of the at least one utensil-holding member 120 may directly influence the amount of utensil-holding sections 124.

The at least two utensil-holding sections 124 may each include a section-depth 127 of between 2-4 inches. However, this section-depth 127 is not limited to 2-4 inches. It is completed that the at least one utensil may include a utensil-width, and the section-depth 127 of the at least two utensil-holding sections 124 may be sized to receive the utensil-width. Due to this, the section-depth 127 may vary in different devices, depending on a type of kitchen utensils envisioned for use with the specific device 100. Further, it should be appreciated that section-depth 127 in each of the utensil-holding sections 124 may not be equal. For example, one utensil-holding section may be configured to hold a spatula having a wide utensil-width, and another utensil-holding section may be configured to hold a teaspoon having a smaller utensil-width. In this example, the section-depth 127 of the utensil-holding section configured to hold the spatula may be wider than the section-depth 127 of the utensil-holding section configured to hold the teaspoon.

As above, the tray 110 may include the base 111 and the raised lip 112 around the periphery of the base 111, and the base 111 and the raised lip 112 may define a tray-capacity 113. Further, as above, the at least one utensil-holding member 120 may be configured to hold the at least one kitchen utensil 5. Preferably, the device 100 may be used by the user whilst they are preparing a meal and cooking using the at least one kitchen utensil 5. Due to this, the tray-capacity 113 may be configured to hold an amount of liquid or food that drips from the at least one kitchen utensil 5. In some embodiments, the tray-capacity 113 may include a volume of between 3-35 cubic inches. In one embodiment, the tray-capacity 113 may include a volume of 6 cubic inches. Further, the raised lip 112 may be configured to balance the at least one kitchen utensil 5 thereon. It may achieve this with a flat edge, a rounded edge, a grooved edge, or an edge including a non-slip material.

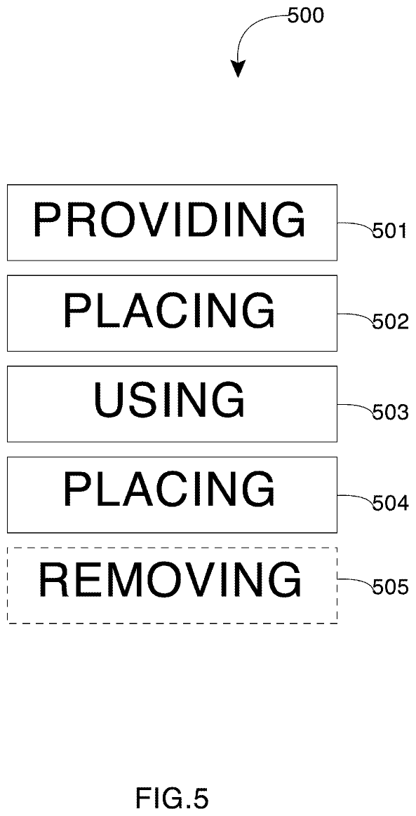

FIG. 5 is a flow diagram illustrating a method of using a device for receiving and holding at least one kitchen utensil 500, according to an embodiment of the present disclosure. As illustrated, the method of using a device for receiving and holding at least one kitchen utensil 500 may include the steps of: providing 501 the device as above; placing 502 the device on the kitchen counter; using 503 the at least one kitchen utensil for food preparation; placing 504 the at least one kitchen utensil within one of the at least two utensil-holding sections whilst not needed; and removing 505 the at least one kitchen utensil from the one of the at least two utensil-holding sections when needed for food preparation.

It should be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for device 100 (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A device for receiving and holding at least one kitchen utensil, the device configured for storage on a kitchen counter, the kitchen counter having a substantially horizontal surface, the device comprising:
a tray including a base and a raised lip around a periphery of the base, the base and the raised lip defining a tray-capacity; and
at least one utensil-holding member attached about a first end of the tray, the at least one utensil-holding member including a length of a tubing formed into a substantially serpentine configuration, the serpentine configuration having a horizontal-length relative to the substantially horizontal surface, the serpentine configuration defining at least two utensil-holding sections, and
wherein the at least two utensil-holding sections are each configured to receive and hold the at least one kitchen utensil.

2. The device of claim 1, wherein the at least one utensil-holding member has a member-height of between 2-4 inches.

3. The device of claim 1, wherein the at least one utensil-holding member has a member-height of 3 inches.

4. The device of claim 1, wherein the at least one utensil-holding member includes the horizontal-length of between 2-4 inches.

5. The device of claim 4, wherein the at least one utensil-holding member includes the horizontal-length of 3 inches.

6. The device of claim 1, wherein the at least two utensil-holding sections each include a section-depth of between 2-4 inches.

7. The device of claim 6, wherein the at least one utensil includes a utensil-width, and wherein the section-depth of the at least two utensil-holding sections is sized to receive the utensil-width.

8. The device of claim 1, wherein the at least one utensil-holding member comprises a metal material.

9. The device of claim 1, wherein the raised lip defines a tray-depth of between ¼-1 inch.

10. The device of claim 1, wherein the tray includes a tray-width of between 5-7 inches.

11. The device of claim 10, wherein the tray includes a tray-width of 6 inches.

12. The device of claim 1, wherein the tray includes a tray-length of between 3-5 inches.

13. The device of claim 12, wherein the tray includes a tray-length of 4 inches.

14. The device of claim 1, wherein the tray-capacity includes a volume of between 3-35 cubic inches.

15. The device of claim 14, wherein the tray-capacity includes a volume of 6 cubic inches.

16. The device of claim 1, wherein the tray comprises ceramic material.

17. The device of claim 1, wherein the tray comprises metal material.

18. The device of claim 1, wherein the tray comprises plastic material.

19. A device for receiving at least one kitchen utensil, the device configured for storage on a kitchen counter, the kitchen counter having a substantially horizontal surface, the device comprising:
a tray including a base and a raised lip around a periphery of the base, the base and the raised lip defining a tray-capacity; and
at least one utensil-holding member attached about a first end of the tray, the at least one utensil-holding member including a length of a cylindrical tubing formed into a substantially serpentine configuration, the serpentine configuration having a horizontal-length relative to the substantially horizontal surface, the serpentine configuration defining at least two utensil-holding sections, and wherein the at least two utensil-holding sections are each configured to hold the at least one kitchen utensil; and
wherein the at least one utensil-holding member includes a member-height of between 2-4 inches;
wherein the at least one utensil-holding member includes the horizontal-length of between 2-4 inches;
wherein the at least one utensil includes a utensil-width, and wherein the section-depth of the at least two utensil-holding sections is sized to receive the utensil-width;
wherein the at least one utensil-holding member comprises a metal material;
wherein the raised lip defines a tray-depth of between ¼-1 inch; and
wherein the tray-capacity includes a volume of between 3-35 inches.

20. A method of using a device for receiving and holding at least one kitchen utensil, the device configured for storage on a kitchen counter, the kitchen counter having a substantially horizontal surface, the method comprising the steps of:
providing the device including:
a tray including a base and a raised lip around a periphery of the base, the base and the raised lip defining a tray-capacity; and
at least one utensil-holding member attached about a first end of the tray, the at least one utensil-holding member including a length of a tubing formed into a substantially serpentine configuration, the serpentine configuration having a horizontal-length relative to the substantially horizontal surface, the serpentine configuration defining at least two utensil-holding sections, and wherein the at least two utensil-holding sections are each configured to receive and hold the at least one kitchen utensil;
placing the device on the kitchen counter;
using the at least one kitchen utensil for food preparation;
placing the at least one kitchen utensil within one of the at least two utensil-holding sections whilst not needed; and
removing the at least one kitchen utensil from the one of the at least two utensil-holding sections when needed for food preparation.
